(19) United States
(12) Patent Application Publication
(10) Pub. No.: US 2007/0222950 A1
(43) Pub. Date: Sep. 27, 2007

(54) Projection apparatus and illmination system

(76) Inventors: Chin-Chung Chen, Kaohsiung City (TW); Mei Liu, Neipu Township (TW); Wei-Chih Lin, Taichung City (TW); Wen-Chih Tai, Sindian City (TW)

Correspondence Address: J.C. Patents, Inc.;Suite 250, 4 Venture, Irvine, CA, 92618, US

(21) Appl. No.: 11/386,248

(22) Filed: Mar. 21, 2006

(51) Int. Cl. G03B 21/28; G03B 21/26

(52) U.S. Cl. 353/37

(57) ABSTRACT

A projection apparatus including an illumination system, a display device and an imaging system is described. The illumination system includes a light source for providing a light beam and an optical mirror disposed on a transmission path of the light beam. In particular, an angle is existed between the optical mirror and the transmission path, and the visible light is reflected by the optical mirror while the ultraviolet light and infrared light pass through the optical mirror. The display device is disposed on a transmission path of the visible light so as to form an image beam. The imaging system is disposed on a transmission path of the image beam.

### BACKGROUND OF THE INVENTION

1. Field of the Invention

The present invention generally relates to a projection apparatus and an illumination system. More particularly, the present invention relates to a projection apparatus capable of preventing the optical components from being damaged and an illumination system capable of improving its lift time.

2. Description of Related Art

For a projection apparatus, a light source having sufficient luminance is required so as to projecting an image having high brightness. An illumination system used in the projection apparatus usually comprises a light source of halide lamp or mercury lamp. The light source has an advantage of high brightness, but has disadvantages of high power consuming, poor lifetime and high heat generation. In particular, if the heat generated from the light source can not be conducted or transmitted out of the projection apparatus, the optical components of the projection apparatus may be damaged.

In details, the projection apparatus mainly includes an illumination system, a display device and an imaging system. In the illumination system, the light beams provided by the light source include visible light for forming images and non-visible light including ultraviolet light and infrared light. If the ultraviolet light and infrared light are transmitted into the optical components, the optical components may be damaged because too much heat from the ultraviolet light and infrared light is focused on. In order to resolve the problem, a filter is disposed at the front of the light source in the prior art so that the ultraviolet light and infrared light can be reflected to the light source to prevent the optical components from being damaged.

However, a lot of heat will be accumulated on the light source because of the ultraviolet light and infrared light irradiation, and ultraviolet light may damage film layers in the device so that the lifetime of the light source is reduced. In addition, the heat that can not be removed to the outside of the apparatus may also damage the optical components.

### SUMMARY OF THE INVENTION

Accordingly, the present invention is directed to a projection apparatus capable of improving the lifetime of the light source and the optical components of the projection apparatus.

The present invention is directed to an illumination system capable of improving the lifetime of the light source of the illumination system.

In the present invention, a projection apparatus comprising an illumination system, at least a display device and an imaging system is provided. The illumination system includes a light source for providing a light beam and an optical mirror disposed on a transmission path of the light beam. In particular, an angle is existed between the optical mirror and the transmission path, and the visible light is reflected by the optical mirror while the ultraviolet light and infrared light may pass through the optical mirror. In addition, the display device is disposed on a transmission path of the visible light for forming an image beam. The imaging system is disposed on a transmission path of the image beam.

An illumination system comprising a light source and an optical mirror is also provided. A light beam is provided by the light source, and the optical mirror is disposed on a transmission path of the light beam. In particular, an angle is existed between the optical mirror and the transmission path, and the visible light is reflected by the optical mirror while the ultraviolet light and infrared light may pass through the optical mirror.

According to an embodiment of the present invention, the light having a wavelength in a range of 420˜700 nm is reflected by the optical mirror.

According to an embodiment of the present invention, the light having a wavelength in a range of 750˜1000 nm and less than 410 nm can pass through the optical mirror.

According to an embodiment of the present invention, the angle existed between the optical mirror and the transmission path is from 30 degree to 60 degree. Preferably, the angle is 45 degree.

According to an embodiment of the present invention, the light source comprises a mercury lamp, a light emitting diode, a metal halide lamp, a halide lamp or a high performance discharge lamp.

According to an embodiment of the present invention, the projection apparatus further comprises a heat sink disposed on a transmission path of the ultraviolet light and infrared light after passing through the optical mirror.

According to an embodiment of the present invention, the projection apparatus further comprises at least an optical device disposed between the optical mirror and the display device. The optical device, for example, comprises a color wheel, a light integration rod, an optical lens, a PS converter or a combination thereof.

According to an embodiment of the present invention, the display device of the projection apparatus comprises a liquid crystal on silicon display device, a high-temperature polysilicon liquid crystal display device or a digital micro-mirror device.

According to an embodiment of the present invention, the at least a display device is a single display device such that the projection apparatus is a projection apparatus having one panel. According to another embodiment of the present invention, the at least a display device comprises three display devices such that the projection apparatus is a projection apparatus having three panels.

The optical mirror is capable of reflecting the visible light and transmitting the ultraviolet light and infrared light, and thus the ultraviolet light and infrared light can not be transmitted into the optical components and the light source. As a result, the lifetime of the light source and the optical components can be improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a drawing showing a projection apparatus having one panel according to an embodiment of the present invention.

FIG. 2 is a drawing showing another projection apparatus having three panels according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

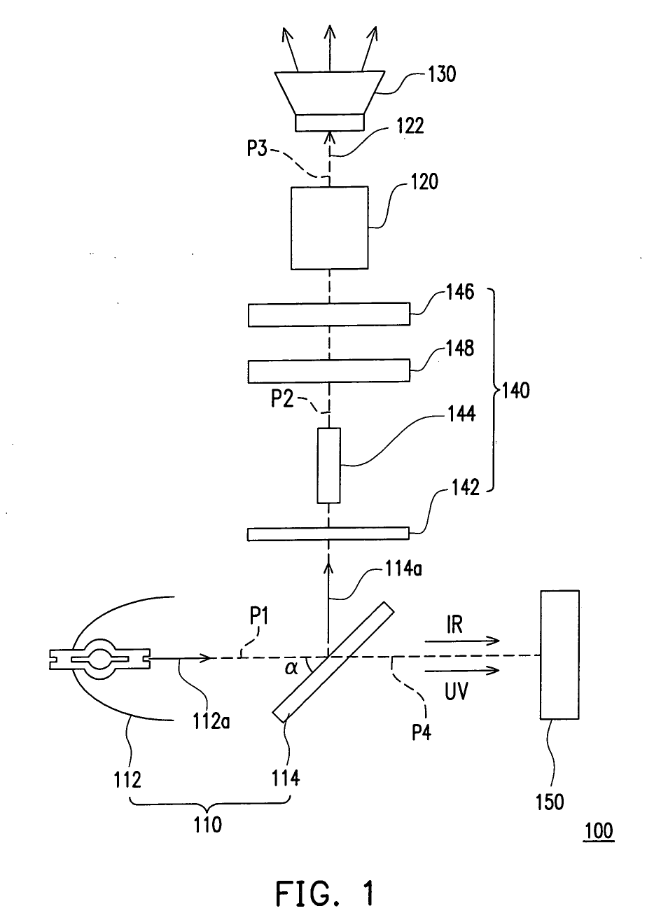

FIG. 1 is a drawing showing a projection apparatus having one panel according to an embodiment of the present invention. As shown in FIG. 1, the projection apparatus 100 comprises an illumination system 110, a display device 120 and an imaging system 130. The illumination system 110 includes a light source 112 and an optical mirror 114. A light beam 112a is provided from the light source 112, and the light beam 112a comprises visible light 114a and non-visible light of ultraviolet light (UV) and infrared light (IR). The light source 112 can be, for example, a mercury lamp, a light emitting diode, a metal halide lamp, a halide lamp or a high performance discharge lamp.

The optical mirror 114 is disposed on a light transmission path PI of the light beam 112a. In particular, an angle α is existed between the optical mirror 114 and the light transmission path PI of the light beam 112a. It should be noted that the visible light 114a is reflected by the optical mirror 114 while the ultraviolet light (UV) and infrared light (IR) can pass through the optical mirror 114.

The display device 120 is disposed on a transmission path P2 of the visible light 114a so as to form an image beam 122 from the visible light 114a. The display device 120, for example, comprises a liquid crystal on silicon display device, a high-temperature polysilicon liquid crystal display device or a digital micro-mirror device. In addition, the imaging system 130 is disposed on a transmission path P3 of. the image beam 122 so that the image beam 122 can be projected on a screen (not shown) to display an image. The imaging system 130 comprises a projection lens, for example.

It should be noted that the angle a existed between the optical mirror 114 and the light transmission path P1 of the light beam 112a is, for example, from 30 degree to 60 degree. Preferably, the angle α is 45 degree. In addition, the visible light 114a having a wavelength in a range of 420˜700 nm is reflected by the optical mirror 114, for example: The ultraviolet light (UV) having a wavelength less than 410 nm and the infrared light (IR) having a wavelength in a range of 750˜1000 nm can pass through the optical mirror 114.

The optical mirror 114 can be commercially obtained. For example, the cold mirror (45° cold mirror, manufactured by Thin Film Imaging Technologies, Inc. (US)) can be used as the optical mirror 114, in which the visible light 114a having a wavelength in a range of 425˜650 nm can be reflected while the infrared light having a wavelength in a range of 800˜1200 nm can pass through. And an additional coating layer that ultraviolet light can pass through is coated on the cold mirror. In addition, similar mirrors can be obtained from other manufacturers, such as ROCODES Electro Optics co. Ltd (Taiwan).

The optical mirror 114 can have a desire characteristic of reflecting the light having a specific wavelength range and transmitting the light having a particular wavelength range by depositing or plating specific thin films.

Please refer to FIG. 1, at least an optical device 140 may further be disposed between the optical mirror 114 and the display device 120 so as to improve displaying quality of the projection apparatus 100. In an embodiment, the optical device 140 includes a color wheel 142, a light integration rod 144, an optical lens 146, and a PS converter 148 arranged sequentially. The color wheel 142 is used to filter uniform and high transmittance color light. The light integration rod 144 is used to improve uniformity of the filtered color light. The PS converter 148 is used to improve light utility and accurately project the filtered color light to the optical lens 146. Then, the visible light 114a is transmitted into the display device 120 from the optical lens 146.

Furthermore, a heat sink 150 may further be disposed on a transmission path P4 of the ultraviolet light (UV) and infrared light (IR) after passing through the optical mirror 114. Such that the heat generated from the ultraviolet light (UV) and infrared light (IR) can be removed to the outside of the projection apparatus 100. In an embodiment, the heat sink 150 is, for example, a fan or other suitable heat sink.

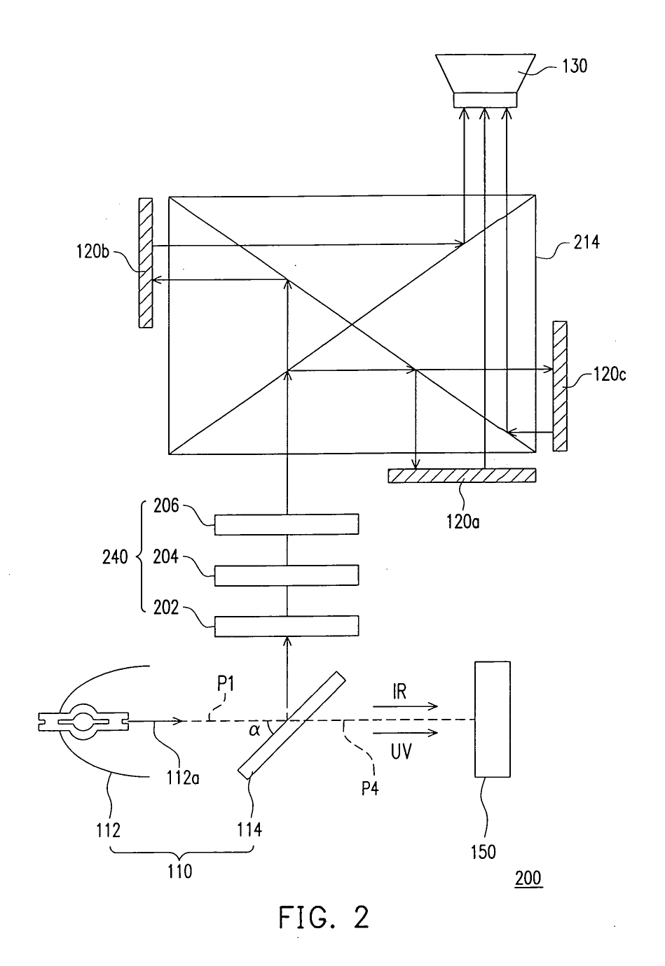

FIG. 2 is a drawing showing another projection apparatus having three panels according to an embodiment of the present invention. The projection apparatus 200 comprises an illumination system 110, three display devices 120a, 120b, 120c and an imaging system 130. In an embodiment, the projection apparatus 200 further comprises optical devices 240 and a color management 214. The illumination system 110 is the same to the illumination system in FIG. 1. Therefore, the ultraviolet light (UV) and infrared light (IR) generated from the light source 112 are transmitted toward the heat sink 150, and the visible light emitted from the light source 112 is transmitted into the color management 214 through the optical devices 240. The optical devices 240 comprise a lens array 202, a PS converter 204 and a lens 206. After the visible light is transmitted into the color management 214, the visible light is split into three beams via reflection and transmission mechanisms in the color management 214 and then the three beams are respectively transmitted into the three display devices 120a, 120b, 120c. After that, the lights reflected from the three display devices 120a, 120b, 120c are transmitted toward the imaging system 130 and then projected to a screen (not shown) by the imaging system 130 and displayed as an image on the screen. It is noted that the projection apparatus having three panels shown in FIG. 2 is an example but not is limited herein. The illumination system 110 can also applied to other type projection apparatuses having three panels.

The optical mirror used in the projection apparatus or in the illumination system has a characteristic of reflecting the visible light and transmitting the ultraviolet light and infrared light. Thus, the visible light can be reflected to the optical components, such as the display device, the imaging system and the optical device, for projecting an image successfully, and the ultraviolet light and infrared light can be transmitted to the outside of the projection apparatus (or transmitted to the heat sink). Therefore, the optical components of the projection apparatus are not irradiated by the ultraviolet light and infrared light so as to improve their lifetime.

Moreover, because the ultraviolet light and infrared light can be transmitted to the outside of the projection apparatus (or transmitted to a heat sink) but not transmitted to the light source of the illumination system, the light source of the illumination system are not irradiated by the ultraviolet light and infrared light so as to improve its lifetime.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A projection apparatus, comprising:
an illumination system comprising:
a light source for providing a light beam;
an optical mirror disposed on a transmission path of the light beam, wherein an angle is existed between the optical mirror and the transmission path, and the visible light is reflected by the optical mirror while the ultraviolet light and infrared light pass through the optical mirror;
at least a display device disposed on a transmission path of the visible light so as to form an image beam; and
an imaging system disposed on a transmission path of the image beam.

2. The projection apparatus according to claim 1, wherein the light having a wavelength in a range of 420˜700 nm is reflected by the optical mirror.

3. The projection apparatus according to claim 1, wherein the lights having a wavelength in a range of 750˜1000 nm and less than 410 nm pass through the optical mirror.

4. The projection apparatus according to claim 1, wherein the angle existed between the optical mirror and the transmission path is from 30 degree to 60 degree.

5. The projection apparatus according to claim 4, wherein the angle existed between the optical mirror and the transmission path is 45 degree.

6. The projection apparatus according to claim 1, wherein the light source comprises a mercury lamp, a light emitting diode, a metal halide lamp, a halide lamp or a high performance discharge lamp.

7. The projection apparatus according to claim 1, further comprising a heat sink disposed on a transmission path of the ultraviolet light and infrared light after passing through the optical mirror.

8. The projection apparatus according to claim 1, further comprising at least an optical device disposed between the optical mirror and the display device.

9. The projection apparatus according to claim 8, wherein the optical device comprises a color wheel, a light integration rod, an optical lens, a PS converter or a combination thereof.

10. The projection apparatus according to claim 1, wherein the display device comprises a liquid crystal on silicon display device, a high-temperature polysilicon liquid crystal display device or a digital micro-mirror device.

11. The projection apparatus according to claim 1, wherein the at least a display device is a single display device such that the projection apparatus is a projection apparatus having one panel.

12. The projection apparatus according to claim 1, wherein the at least a display device comprises three display devices such that the projection apparatus is a projection apparatus having three panels.

13. An illumination system, comprising:
a light source for providing a light beam; and
an optical mirror disposed on a transmission path of the light beam, wherein an angle is existed between the optical mirror and the transmission path, and the visible light is reflected by the optical mirror while the ultraviolet light and infrared light pass through the optical mirror.

14. The illumination system according to claim 13, wherein the light having a wavelength in a range of 420˜700 nm is reflected by the optical mirror.

15. The illumination system according to claim 13, wherein the lights having a wavelength in a range of 750·1000 nm and less than 410 nm pass through the optical mirror.

16. The illumination system according to claim 13, wherein the angle existed between the optical mirror and the transmission path is from 30 degree to 60 degree.

17. The illumination system according to claim 16, wherein the angle existed between the optical mirror and the transmission path is 45 degree.

18. The illumination system according to claim 13, wherein the light source comprises a mercury lamp, a light emitting diode, a metal halide lamp, a halide lamp or a high performance discharge lamp.

19. The illumination system according to claim 13, further comprising a heat sink disposed on a transmission path of the ultraviolet light and infrared light after passing through the optical mirror.
